(19) United States
(12) Patent Application Publication
(10) Pub. No.: US 2014/0160515 A1
(43) Pub. Date: Jun. 12, 2014

(54) IMAGE READING APPARATUS, METHOD FOR CONTROLLING IMAGE READING APPARATUS, AND STORAGE MEDIUM

(71) Applicant: CANON KABUSHIKI KAISHA, Tokyo (JP)

(72) Inventor: Junichi Goda, Kawasaki-shi (JP)

(73) Assignee: CANON KABUSHIKI KAISHA, Tokyo (JP)

(21) Appl. No.: 14/097,074

(22) Filed: Dec. 4, 2013

(30) Foreign Application Priority Data
Dec. 6, 2012 (JP) 2012-266914

(51) Int. Cl. H04N 1/00

(52) U.S. Cl. CPC H04N 1/00891; H04N 1/00803
USPC 358/1.14

(57) ABSTRACT

An image processing apparatus can achieve power saving while preventing documents from being incorrectly placed upside down. A control method for controlling the image processing apparatus includes processing, by a first image processing unit, image data, read by a first reading unit, on a first side of documents, processing, by a second image processing unit, image data, read by a second reading unit, on a second side of the documents, determining whether the first reading unit or the second reading unit has read a predetermined number of blank pages, and if it is determined that the first reading unit or the second reading unit has read the predetermined number blank pages, performing power control to shut off power supply to the first image processing unit or the second image processing unit before reading the documents is completed.

### BACKGROUND

1. Field

Aspects of the present invention generally relate to an image reading apparatus, a method for controlling the image reading apparatus, and a storage medium.

2. Description of the Related Art

Conventionally, image processing apparatuses for reading images on both sides of documents are widely used. For example, there has been proposed an apparatus, which is provided with two image sensors disposed on both the front side and back side of a document conveyance path to simultaneously read images on both sides of documents by a one-time conveyance, without turning the documents upside down (see Japanese Patent Application Laid-Open No. 2011-61695).

Also, a reading apparatus capable of reading both sides of documents has been proposed, in which, when performing one-sided reading to read the front side or back side of documents, a reading control unit for the side not to be read is set into a power saving mode to realize power saving (see Japanese Patent Application Laid-Open No. 2010-269934).

Also, there has been proposed a reading apparatus capable of performing two-sided reading, which reads images on both sides of documents to detect whether there are blank pages on the front side or back side of the documents in order to detect incorrect placement of the documents, and then saves images on the non-blank side as read images (see Japanese Patent Application Laid-Open No. 5-48835).

However, in a reading apparatus capable of performing simultaneous two-sided reading according to the conventional techniques, in order to prevent documents from being incorrectly placed upside down, it is necessary to read both sides of documents to detect whether there are blank pages on the front side or back side of the documents. Therefore, detection of blank pages requires both front-side and back-side reading control units to be activated. Thus, it is not possible to set either of the front-side and back-side reading control units into a power saving mode to reduce power consumption of the apparatus.

### SUMMARY

According to an aspect of the present invention, an image processing apparatus includes a first image processing unit configured to process image data, read by a first reading unit, on a first side of at least one document, a second image processing unit configured to process image data, read by a second reading unit, on a second side of the at least one document, a determining unit configured to determine whether the first reading unit or the second reading unit has read a predetermined number of blank pages, and a power control unit configured to, if the determining unit determines that the first reading unit or the second reading unit has read the predetermined number of blank pages, shut off power supply to the first image processing unit or the second image processing unit before reading the at least one document is completed.

Further features of the present disclosure will become apparent from the following description of exemplary embodiments (with reference to the attached drawings).

### BRIEF DESCRIPTION OF THE DRAWINGS

FIG. 1 illustrates an appearance of an image processing apparatus employing an image reading apparatus.

FIG. 2 is a schematic view illustrating a configuration of a scanner unit and a document feeder illustrated in FIG. 1.

FIG. 3 is a block diagram illustrating a configuration of a controller of the image reading apparatus.

FIG. 4 is a plan view illustrating an example of a configuration of an operation unit illustrated in FIG. 1.

FIG. 5 is a block diagram illustrating an example of a configuration of a scanner interface (IF) image processing unit illustrated in FIG. 3.

FIG. 6 illustrates an example of a blank page detection table.

FIG. 7 is a flowchart illustrating a method for controlling the image reading apparatus.

FIG. 8 is a flowchart illustrating a method for controlling the image reading apparatus.

FIG. 9 is a flowchart illustrating a method for controlling the image reading apparatus.

FIG. 10 is a flowchart illustrating a method for controlling the image reading apparatus.

FIG. 11 illustrates an example of a user interface (UI) screen displayed on an operation unit illustrated in FIG. 1.

FIG. 12 is a flowchart illustrating a method for controlling the image reading apparatus.

FIG. 13 is a block diagram illustrating an example of a configuration of a printer IF image processing unit.

FIG. 14 illustrates a read image management table.

FIG. 15 is a flowchart illustrating a method for controlling the image reading apparatus.

### DESCRIPTION OF THE EMBODIMENTS

Various exemplary embodiments, features, and aspects will be described in detail below with reference to the drawings.

<Description of System Configuration>

### <Appearance of Image Processing Apparatus>

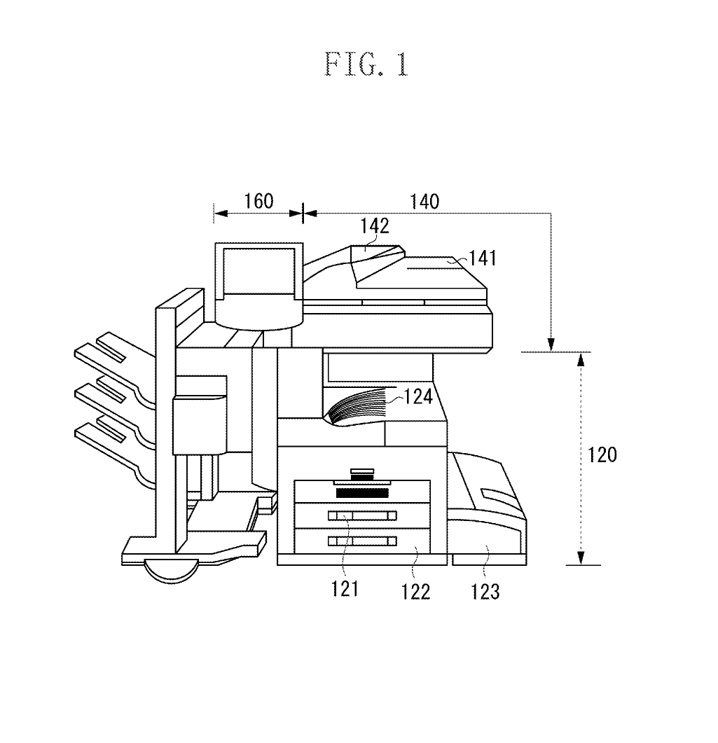

FIG. 1 illustrates an appearance of an image processing apparatus which employs an image reading apparatus according to a first exemplary embodiment.

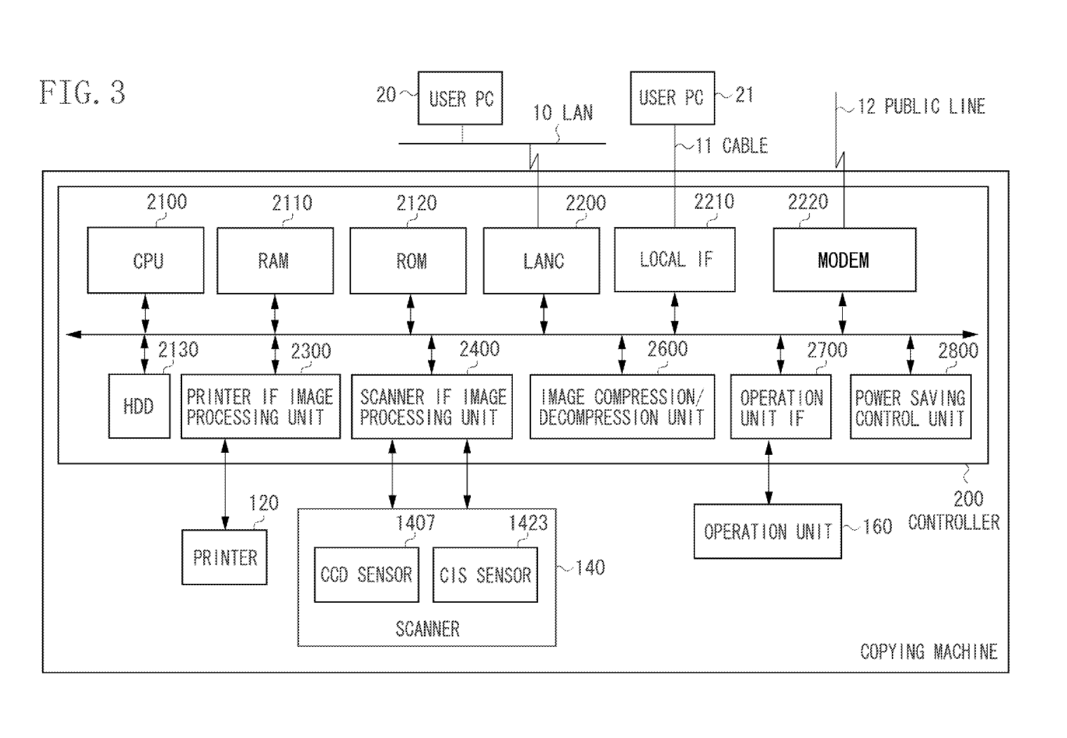

Referring to FIG. 1, a scanner 140, which serves as an image reading unit, performs an exposure scanning of an image on a document by using the light emitted from an illumination lamp, and inputs the reflected light from the image into a linear image sensor (charge-coupled device (CCD) sensor) and a contact image sensor (CIS) to convert information of the image into an electrical signal. The scanner 140 further converts the electrical signal into a luminance signal including colors of red (R), green (G), and blue (B), and outputs the luminance signal to a controller 200 as image data (see FIG. 3). The scanner 140 has a simultaneous two-sided reading mode that can simultaneously read the front side and back side of a document by using the above-mentioned CCD sensor and CIS. The scanner 140 also has a one-sided reading mode that can read only either of the front side and back side of a document by using only either of the CCD sensor and the CIS.

Documents are placed on a tray 142 of a document feeder 141. When a user issues an instruction to start reading the documents via an operation unit 160, the controller 200 transmits an instruction to read the documents to the scanner 140. When receiving the instruction, the scanner 140 performs a reading operation of the documents while feeding the documents one by one from the tray 142 of the document feeder 141.

A printer 120 is an image forming device which receives image data from the controller 200 and forms the data on a sheet. The image forming system according to the first exemplary embodiment employs an electrophotographic method using a photosensitive drum or a photosensitive member belt. The printer 120 has a plurality of sheet cassettes 121, 122 and 123 to accommodate different sheet sizes or different sheet orientations. Printed sheets are discharged to a discharge tray 124.

<Scanner Unit>

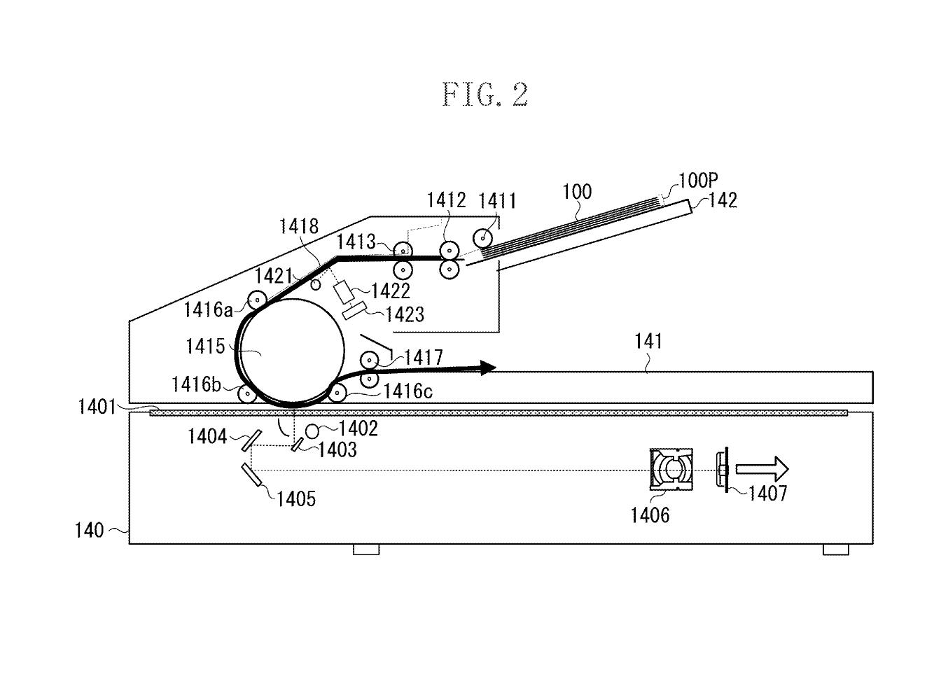

FIG. 2 is a schematic view illustrating a key configuration and reading operation of the scanner 140 and the document feeder 141 illustrated in FIG. 1. The flow of documents according to the first exemplary embodiment will be described below.

Referring to FIG. 2, a batch of documents 100P to be read is placed on the tray 142. A feeding roller 1411, a pair of separation and conveyance rollers 1412, and a pair of registration rollers 1413 are disposed downstream of the document conveyance direction illustrated in FIG. 2. The feeding roller 1411 is driven to rotate by a driving unit (not illustrated) to feed the batch of documents 100P placed on the tray 142 one by one. The pair of separation and conveyance rollers 1412 disposed in the downstream side of the feeding roller 1411 separates an uppermost document 100 from the batch of documents 100P and conveys the document 100. The pair of registration rollers 1413 disposed in the downstream side of the pair of separation and conveyance rollers 1412 includes a registration roller rotatably connected to a driving unit and a driven roller. The timing of subsequent conveyance or image-reading of the document 100 is based on the start of rotation of the pair of registration rollers 1413.

The driving unit for driving the feeding roller 1411, the pair of separation and conveyance rollers 1412, and the pair of registration rollers 1413 is, for example, a stepping motor.

The document 100 discharged from the pair of registration rollers 1413 moves along a guide plate 1418 and is conveyed along the outer circumference of a rotating large-diameter conveyance roller 1415 while being nipped by the conveyance roller 1415 and driven rollers 1416a, 1416b and 1416c. The document is continuously conveyed along the outer circumference of the conveyance roller 1415, and is discharged onto the document feeder 141 by a discharge roller 1417.

A description will be given of sensors and light sources for reading an image of a document while the document is being conveyed as described above. In the following description, the top side of the document 100 placed on the tray 142 is defined as the front side and the bottom side thereof as the back side.

A description of a reading unit for the front side of the document 100 will be given first.

While the document 100 is being conveyed, an illumination lamp 1402 irradiates the front side of the document 100, and the reflected light therefrom is image-formed on a CCD sensor 1407 by a lens 1406 via mirrors 1403, 1404 and 1405. The reflected light input into the CCD sensor 1407 is converted into an electrical signal by the CCD sensor 1407 and is input into a scanner IF image processing unit 2400 (see FIG. 3).

Subsequently, a description will be given of a reading unit for the back side of the document 100. While the document 100 is being conveyed, an illumination lamp 1421 irradiates the back side of the document 100, and the reflected light therefrom is image-formed on a CIS 1423 by a lens 1422. The reflected light input into the CIS 1423 is converted into an electrical signal by the CIS 1423 and is input into the scanner IF image processing unit 2400.

As described above, the scanner 140 is capable of simultaneously reading the front side and the back side of a document. Hereinafter, a mode to simultaneously read the front side and the back side of a document will be referred to as a simultaneous two-sided reading mode. In addition to the simultaneous two-sided reading mode, the scanner 140 has a one-sided reading mode for reading only either of the front side and back side of a document. In the one-sided reading mode, a reading operation cannot be performed on both sides of a document.

<Controller>

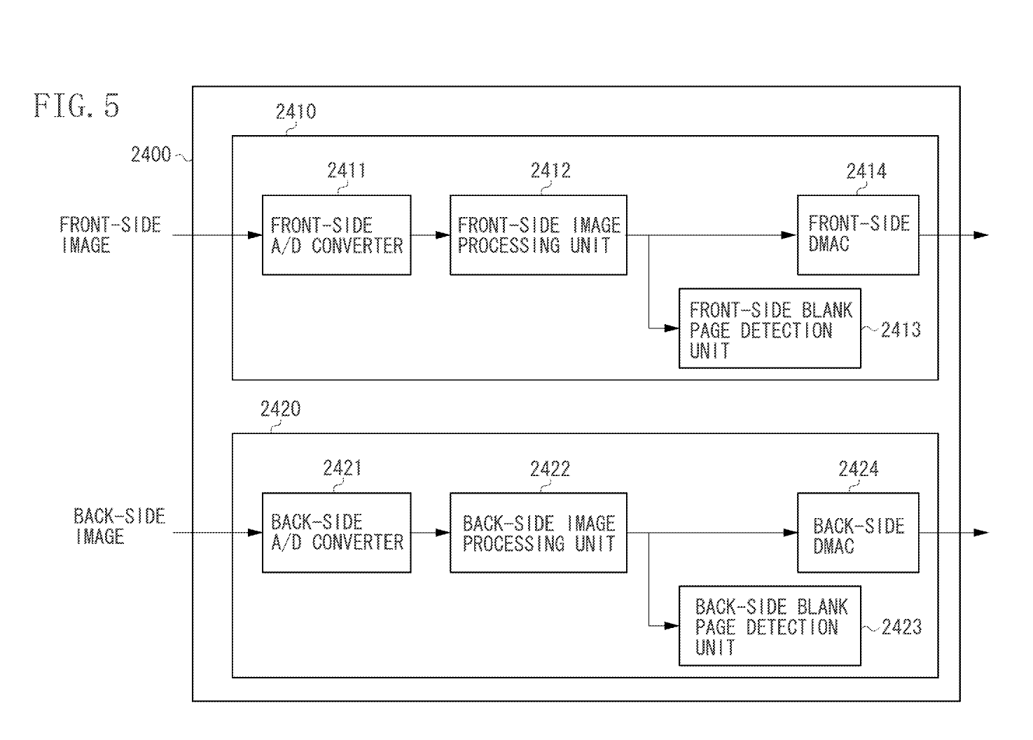

FIG. 3 is a block diagram illustrating a configuration of a controller of the image reading apparatus according to the first exemplary embodiment. According to the first exemplary embodiment, a first image processing unit (i.e., a front-side image processing control unit 2410 in the scanner IF image processing unit 2400 (see FIG. 5)) is provided to process image data on the first side of a document, which is read by a first reading unit (i.e., the CCD 1407). Also, a second image processing unit (i.e., a back-side image processing control unit 2420 (see FIG. 5)) is provided to process image data on the second side of the document, which is read by a second reading unit (i.e., the CIS 1423).

Referring to FIG. 3, the controller 200 is connected to the scanner 140 serving as an image input device, the printer 120 serving as an image output device, a local area network (LAN) 10, and a public line (or a wide area network (WAN)) 12. The controller 200 integrally controls the entire operation of the image processing apparatus including the image reading apparatus as well as controls the input and output of image information and device information.

A CPU 2100 is a processor that controls the entire part of a copying machine and integrally controls access to various kinds of devices connected thereto based on a control program stored in a ROM 2120. Further, the CPU 2100 integrally controls various kinds of processing executed within the controller 200. A RAM 2110 is a system work memory necessary for operation of the CPU 2100 as well as an image memory for temporarily storing image data. The ROM 2120 is a boot ROM storing a boot program of the system. An HDD 2130 is a hard disk drive mainly storing information (system software) necessary for starting and operating a computer, and image data. These data may be stored in, not limited to the HDD 2130, a recording medium capable of maintaining the memory even when power is turned off.

An LANC (LAN controller) 2200 is connected to the LAN 10 for input/output of image data and device control information from/to a user PC 20. A local IF 2210 is an interface for a universal serial bus (USB) or Centronics etc., which is connected to a user PC 21 or the printer 120 via a cable 11 for input/output of data. A MODEM 2220 is connected to the public line 12 for input/output of data.

A printer IF image processing unit 2300 is connected to the printer 120 to communicate with a CPU mounted on the printer 120. The printer IF image processing unit 2300 also performs synchronous/asynchronous conversion of image data and image processing for print output.

The scanner IF image processing unit 2400 is connected to the scanner 140 including the document feeder 141 to communicate with a CPU (not illustrated) mounted on the scanner 140. The scanner IF image processing unit 2400 also performs synchronous/asynchronous conversion of image data, and image processing of read images including blank page detection processing.

An image compression/decompression unit 2600 performs processing for compressing multi-value image data into Joint Photographic Experts Group (JPEG), and binary image data into joint bi-level image experts group (JBIG), modified modified read (MMR), modified huffman (MH), or the like. The image compression/decompression unit 2600 also decompresses the compressed image data as appropriate.

An operation unit IF 2700 is an interface for output of image data to be displayed on the operation unit 160 from the controller 200 to the operation unit 160, and for output of information, which is input by a user of the copying machine via the operation unit 160, to the controller 200.

A power saving control unit 2800 performs power saving control within the controller 200, and also issues an instruction to perform power saving control to the scanner 140. Particularly, a feature of the power control according to the first exemplary embodiment is that power saving control is performed separately on the sensor and image processing control unit that are necessary for reading the front side of a document and on the sensor and image processing control unit that are necessary for reading the back side of the document.

More specifically, in power saving control of the sensor and image processing control unit necessary for reading the front side of a document, power supply to a light source of the illumination lamp 1402 and to the CCD sensor 1407 is turned off. Further, power supply to the front-side image processing control unit 2410 for front-side processing in the scanner IF image processing unit 2400 described later is turned off, or clock gating is performed to stop supplying clocks.

Likewise, in power saving control of the sensor and image processing control unit necessary for reading the back side of a document, power supply to a light source of the illumination lamp 1421 and to the CIS 1423 is turned off. Also, power supply to the back-side image processing control unit 2420 for back-side processing in the scanner IF image processing unit 2400 described later is turned off, or clock gating is performed to stop supplying clocks.

<Operation Unit>

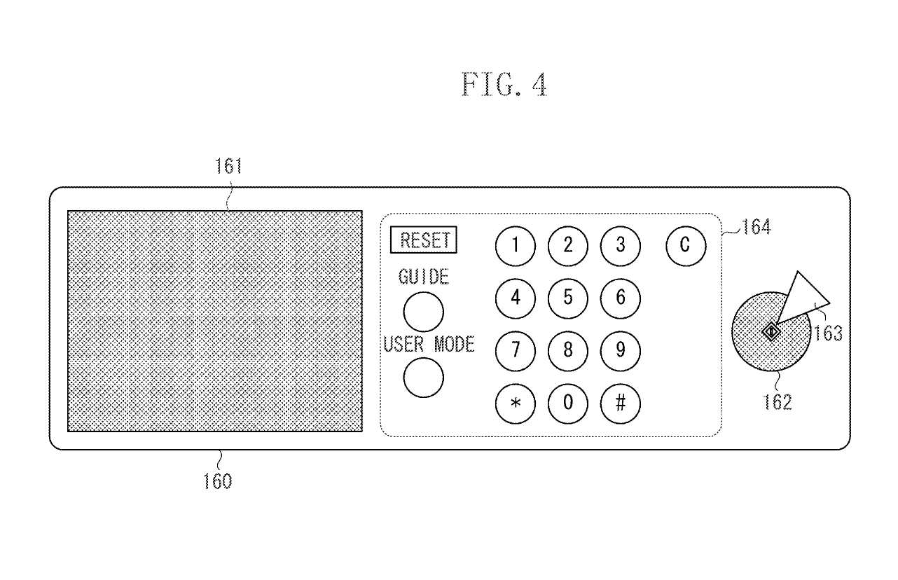

FIG. 4 is a plan view illustrating an example of a configuration of the operation unit 160 illustrated in FIG. 1.

Referring to FIG. 4, a liquid crystal panel 161 is a combination of a liquid crystal and a touch panel to display an operation screen. When a user presses a displayed key, the input information is transmitted to the controller 200. A start key 162 is used to start the operation of reading and printing a document image and to give an instruction to start other functions. The start key 162 includes a two-color (green and red) light-emitting diode (LED) light. The lit green LED light represents that the image processing apparatus is ready to start operation. The lit red LED light represents the image processing apparatus is not able to start operation. A stop key 163 is used to stop an operation in progress. A group of hard keys 164 include a numeric keypad, a clear key, a reset key, a guide key, and a user mode key.

<Scanner IF Image Processing Unit>

FIG. 5 is a block diagram illustrating an example of a configuration of the scanner IF image processing unit 2400 illustrated in FIG. 3.

Referring to FIG. 5, the front-side image processing control unit 2410 performs image processing of the front-side image of a document, which is input from the CCD sensor 1407 of the scanner 140, and then stores the processed image in the RAM 2110. The back-side image processing control unit 2420 also performs processing similar to that of the front-side image processing control unit 2410. The difference from the front-side image processing control unit 2410 is that the back-side image processing control unit 2420 performs image processing of the back side of the document, which is input from the CIS 1423 of the scanner 140.

A front-side analog-digital (A/D) converter 2411 converts an analog signal received from the CCD sensor 1407 into a digital signal to output the signal to a front-side image processing unit 2412. The front-side image processing unit 2412 converts the order of input pixels, which varies depending on the sensor, into an image format to be handled inside the apparatus.

Further, the front-side image processing unit 2412 performs image processing, which is generally performed on an input image by a multifunction peripheral. For example, image processing such as shading correction in which correction processing is performed on luminance unevenness due to a characteristic of an optical system or an imaging system to obtain an image with uniform brightness, conversion into standardized color space, or filter processing for color correction.

A front-side blank page detection unit 2413 determines whether an input front-side image is a blank page. If the front-side blank page detection unit 2413 determines that the input front-side image is a blank page, the front-side blank page detection unit 2413 notifies the CPU 2100 that the input front-side image is a blank page. Hereinafter, this notification function will be referred to as blank page notification. A unit for determining an input image as a blank page is, for example, counts dots of the input image on a pixel-by-pixel basis, and if the total of the dots of the input image for one page is smaller than the threshold value, determines that the image is a blank page.

A front-side direct memory access controller (DMAC) 2414 transfers the input front-side image to the RAM 2110 without via the CPU 2100. A back-side A/D converter 2421 converts an analog signal received from the CIS 1423 into a digital signal to output the digital signal to a back-side image processing unit 2422.

The back-side image processing unit 2422 performs processing similar to that of the front-side image processing unit 2412 on a back-side image. A back-side blank page detection unit 2423 performs processing similar to that of the front-side blank page detection unit 2413 on a back-side image. A back side DMAC 2424 performs a process similar to that of the front-side DMAC 2414 on a back-side image.

<Blank Page Detection Table>

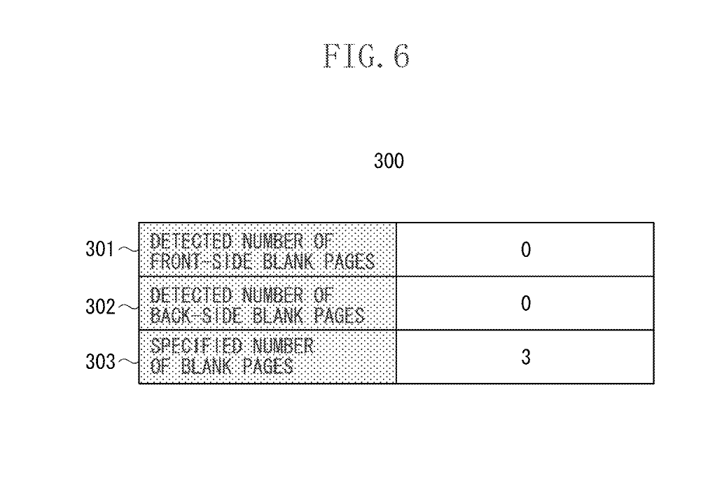

FIG. 6 illustrates an example of a blank page detection table 300 which is managed on the HDD 2130 illustrated in FIG. 3. In the first exemplary embodiment, an example, in which the blank page detection table 300 is held by a memory such as the HDD 2130 and is managed by the CPU 2100, is given. However, another storage medium may be used.

Referring to FIG. 6, a detected number of front-side blank pages 301 is an item which is incremented when the CPU 2100 receives from the front-side blank page detection unit 2413 a blank page notification about the number of blank pages in the front-side document images read by the scanner 140.

A detected number of back-side blank pages 302 is an item which is incremented when the CPU 2100 receives from the back-side blank page detection unit 2423 a blank page notification about the number of blank pages in the back-side document images read by the scanner 140.

The detected number of front-side blank pages 301 and the detected number of back-side blank pages 302 are valid within one scan job, and are controlled by the CPU 2100 to ensure that the count starts from “0” at the start of a scan job. Here, one scan job is a unit of reading processing to be performed on all the batch of documents 100P placed on the document feeder 141.

A specified number of blank pages 303 is an item which is used as a criterion for executing the power saving control described later when either the detected number of front-side blank pages 301 or the detected number of back-side blank pages 302 has reached the value set in the specified number of blank pages 303.

Briefly, in reading processing of documents within one scan job, when the number of front-side or back-side images determined as blank pages has reached the value set in the specified number of blank pages 303, the CPU 2100 executes the power saving control described later.

<Flow of Image Reading>

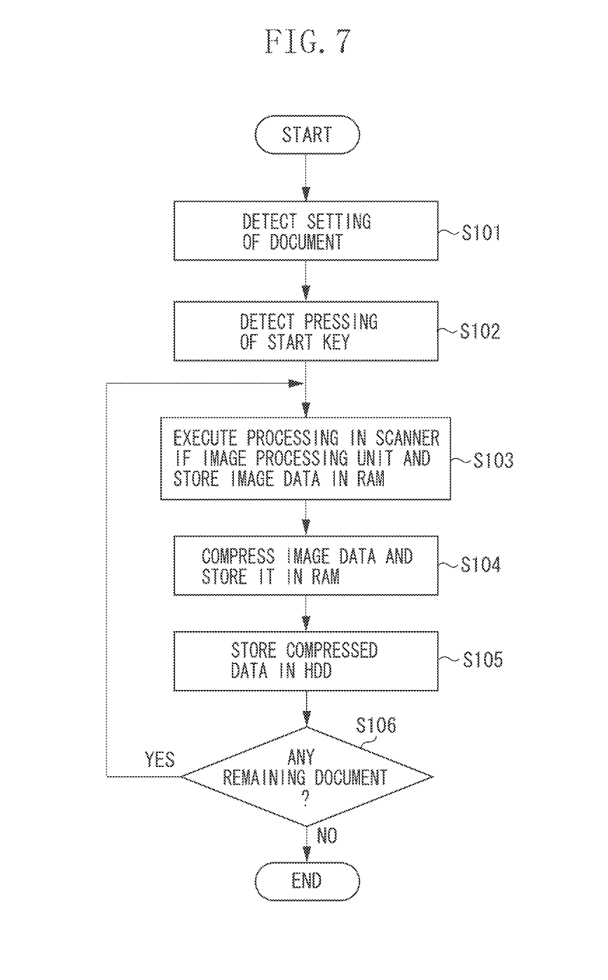

FIG. 7 is a flowchart illustrating a method for controlling the image reading apparatus according to the first exemplary embodiment. This is an example of processing from when the scanner 140 illustrated in FIG. 1 reads images on the batch of documents 100P until when the read image data is stored in the HDD 2130. The processing illustrated in the flowchart in FIG. 7 is realized by the CPU 2100 executing a program stored in the HDD 2130.

In step S101, the CPU 2100 detects that a plurality of documents to be read has been placed on the tray 142 of the document feeder 141.

In step S102, when the CPU 2100 detects a press of the start key 162 on the operation unit 160 by a user operation, the CPU 2100 causes the scanner 140 to start reading the documents. According to the first exemplary embodiment, in step S102, the scanner 140 operates in a simultaneous two-sided reading mode for at least the first document.

In step S103, the CPU 2100 inputs the image data into the scanner IF 2400 to subject the image data to image processing and blank page detection processing, and stores the image data in the RAM 2110.

In step S104, the CPU 2100 inputs the image data, which is stored in the RAM 2110 in step S103, into the image compression/decompression unit 2600. The image compression/decompression unit 2600 compresses the input image data and stores the compressed image data in the RAM 2110.

In step S105, the CPU 2100 stores the image data, which is stored in the RAM 2110 in step S104, in the HDD 2130.

In step S106, the CPU 2100 determines whether to continue reading images. The determination is made based on whether any document still remains on the tray 142 of the document feeder 141. If the CPU 2100 determines that any document to be read remains on the tray 142 (YES in S106), the processing returns to step S103. If the CPU 2100 determines that no document to be read remains, the processing ends.

<Flow of Blank Page Detection and Power Saving Control>

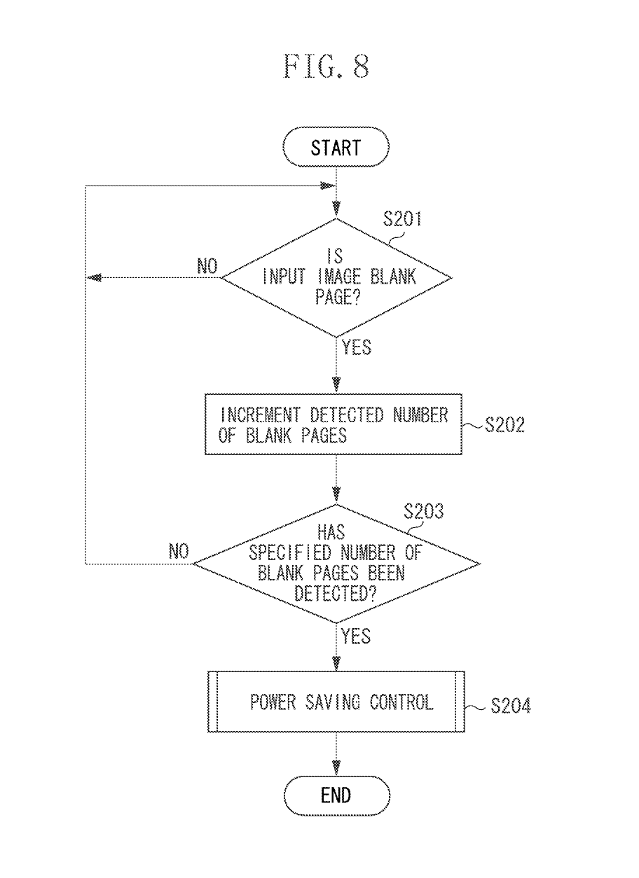

FIG. 8 is a flowchart illustrating a method for controlling the image reading apparatus according to the first exemplary embodiment. This is an example of power saving control executed based on blank page detection. The processing illustrated in the flowchart in FIG. 8 is realized by the CPU 2100 executing a program stored in the HDD 2130. A description will be given of processing for determining in a two-sided reading mode whether the first reading unit and the second reading unit are continuously reading specific images (blank images) on the first side and second side of documents, respectively. The image reading apparatus is configured to allow the user to specify the number of specific documents to be read by the first reading unit (the CCD sensor 1407) or by the second reading unit (the CIS 1423) via the operation unit 160.

In step S201, the CPU 2100 determines whether a blank page notification is transmitted from the front-side blank page detection unit 2413 or from the back-side blank page detection unit 2423. If the CPU 2100 determines that no blank page notification is transmitted (NO in S201), the CPU 2100 stays in step S201. If the CPU 2100 determines that a blank page notification is transmitted, the processing proceeds to step S202.

In step S202, the CPU 2100 determines whether a blank page notification is transmitted from either or both of the front-side blank page detection unit 2413 and the back-side blank page detection unit 2423, and increments the number of detected number of front-side blank pages 301 or the detected number of back-side blank pages 302 according to the notification. For example, if a blank page notification is transmitted only from the back-side blank page detection unit 2423, the CPU 2100 increments the value of the detected number of back-side blank pages 302.

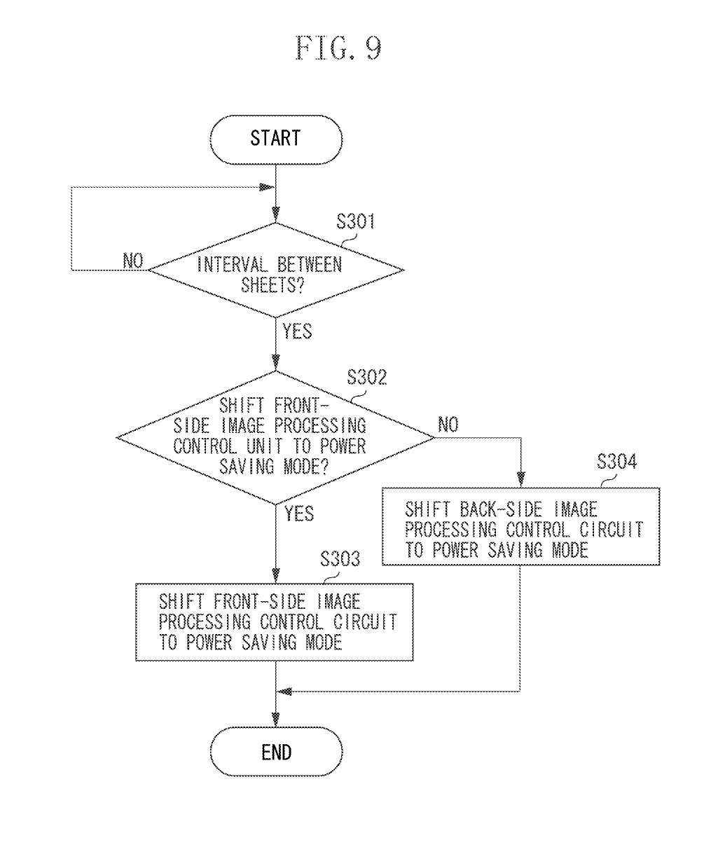

In step S203, the CPU 2100 determines whether the number of blank pages stored in the detected number of front-side blank pages 301 or in the detected number of back-side blank pages 302 matches the value set in the specified number of blank pages 303. If the CPU 2100 determines that the detected number does not match the set value (NO in S203), the processing returns to step S201. If the CPU 2100 determines that the detected number matches the set value (YES in S203), the processing proceeds to step S204 to execute power saving control. The power saving control in step S204 will be described in detail, referring to a flowchart in FIG. 9.

<Flow of Power Saving Control>

FIG. 9 is a flowchart illustrating a method for controlling the image reading apparatus according to the first exemplary embodiment. This is an example of power saving control performed by the image reading apparatus according to the first exemplary embodiment. The processing illustrated in the flowchart in FIG. 9 is realized by the CPU 2100 executing a program stored in the HDD 2130. If the CPU 2100 determines that the CIS 1423 or the CCD sensor 1407 is continuously reading specific images, the CPU 2100 switches from a two-sided reading mode to a one-sided reading mode while reading documents. A description will be given of a case in which the CPU 2100 performs power control to shut down power supply to the front-side image processing control unit 2410 including the CCD 1407 or power supply to the back-side image processing control unit 2420 including the CIS 1423.

In step S301, the CPU 2100 determines whether the document reading process is in the interval between sheets. Here, the wording “interval between sheets” means an interval during which no document 100 passes through the surface of a document positioning glass 1401, i.e., an interval between documents to be read. If the CPU 2100 determines that the reading process is not in the interval between sheets (NO in step S301), the CPU 2100 stays in step S301. If the CPU 2100 determines that the reading process is in the interval between sheets (YES in step S301), the processing proceeds to step S302.

In step S302, the CPU 2100 determines which to shift to a power saving mode, the front-side image processing control unit 2410 or the back-side image processing control unit 2420. In the first exemplary embodiment, the criterion for the determination is that, if either the detected number of front-side blank pages 301 or the detected number of back-side blank pages 302 matches the value set in the specified number of blank pages 303, shift to a power saving mode, as described in step S203 illustrated in FIG. 8.

More specifically, if the detected number of front-side blank pages 301 matches the specified number of blank pages 303, the CPU 2100 determines to shift the front-side image processing control unit 2410 to a power saving mode, and the processing proceeds to step S303. If the detected number of back-side blank pages 302 matches the specified number of blank pages 303, the CPU 2100 determines to shift the back-side image processing control unit 2420 to a power save mode, and the processing proceeds to step S304.

In step S303, the CPU 2100 uses the power saving control unit 2800 to perform power saving control of the sensor and the image processing control circuit that are necessary for front-side image reading, and then the processing ends.

In step S304, the CPU 2100 uses the power saving control unit 2800 to perform power saving control of the sensor and the image processing control circuit that are necessary for back-side image reading, and then the processing ends.

As described above, the CPU 2100 counts the number of blank pages on the front side and the back side of documents, and when the number has reached a certain threshold value, the reading processing circuit for the blank page side is shifted to a power saving mode. In the following case, by adopting the technique according to the first exemplary embodiment, a power saving effect can be obtained while preventing incorrect placement of documents.

For example, there may be a case in which a user attempts to operate an image processing apparatus in a one-side reading mode while erroneously placing 100 pages of documents upside down, i.e., a case in which images are printed only on the back side of the 100 pages of documents.

It is assumed here that the value of 5 is specified in the specified number of blank pages 303. After the start of reading the 100 pages of documents, when both sides of the first five pages have been read, the CPU 2100 detects that the front side of the first 5 pages is blank. At this timing, or at the timing when reading of the sixth page is completed if the sixth page is being read, the CPU 2100 shifts the front-side reading processing circuit to a power saving mode. This allows only the back-side reading processing circuit to continue the operation for the subsequent pages, thereby reducing power consumption of the front-side reading processing circuit.

A second exemplary embodiment will be described below.

In the first exemplary embodiment, the image reading apparatus counts the number of blank pages on the front side and the back side of read images, and then shifts the reading processing circuit for the blank page side to a power saving mode. From a user's viewpoint, a feature of the first exemplary embodiment is that, once a user starts a reading operation, the reading processing circuit can be automatically shifted to a power saving mode when the criterion is satisfied (i.e., when the number of front-side or back-side blank pages in read documents has reached the threshold value).

However, there may be a case where the number of detected blank pages has reached the value set in the specified number of blank pages 303, although a user actually desires to read both sides of images, and then the reading processing circuit for the blank page side is automatically shifted to a power saving mode to stop the reading operation.

According to the second exemplary embodiment, instead of performing the blank page detection, a preview of read images is displayed on an operation panel to allow a user to select whether to carry out two-sided reading or one-sided reading.

<Flow of Image Preview>

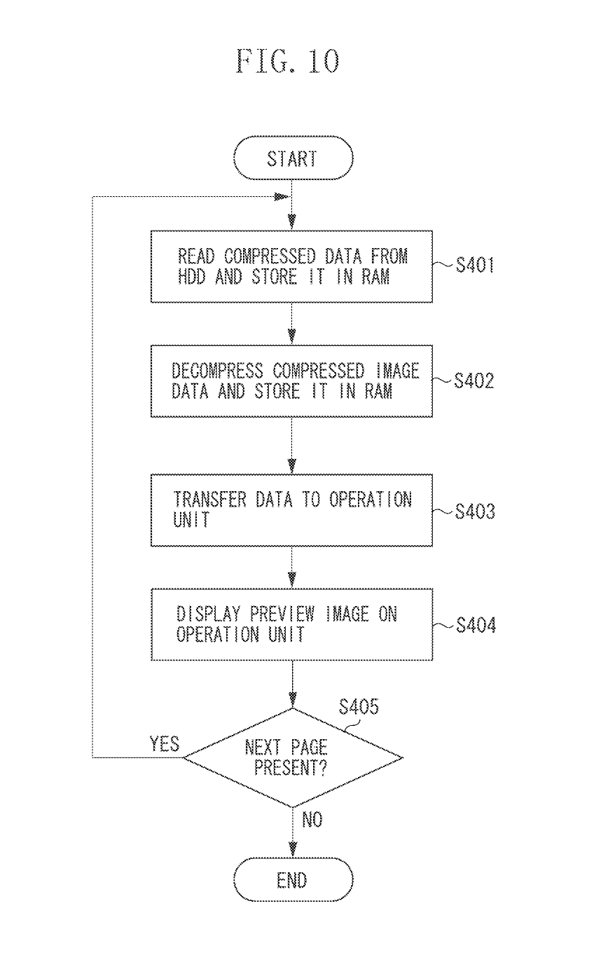

FIG. 10 is a flowchart illustrating a method for controlling the image reading apparatus according to the second exemplary embodiment. This is an example of processing in which the images stored in the HDD 2130, which have been described referring to FIG. 7, are read out to be displayed as preview images on the liquid crystal panel 161 of the operation unit 160. The processing illustrated in the flowchart in FIG. 10 is realized by the CPU 2100 executing a program stored in the HDD 2130.

In the second exemplary embodiment, the flow of image preview illustrated in FIG. 10 is executed simultaneously with the flow of image reading illustrated in FIG. 7.

In step S401, the CPU 2100 reads out the compressed data, which is stored in the HDD 2130 in step S105 illustrated in FIG. 7, and stores the compressed data in the RAM 2110.

In step S402, the CPU 2100 inputs the compressed image data, which is stored in the RAM 2110 in step S401, to the image compression/decompression unit 2600. The image compression/decompression unit 2600 decompresses the input compressed image data and stores the decompressed image data in the RAM 2110.

In step S403, the CPU 2100 inputs the image data, which is stored in the RAM 2110 in step S402, to the operation unit 160. The CPU 2100 may input the image data to the operation unit 160 after reducing the resolution of the image data using a resolution conversion unit (not illustrated), if necessary.

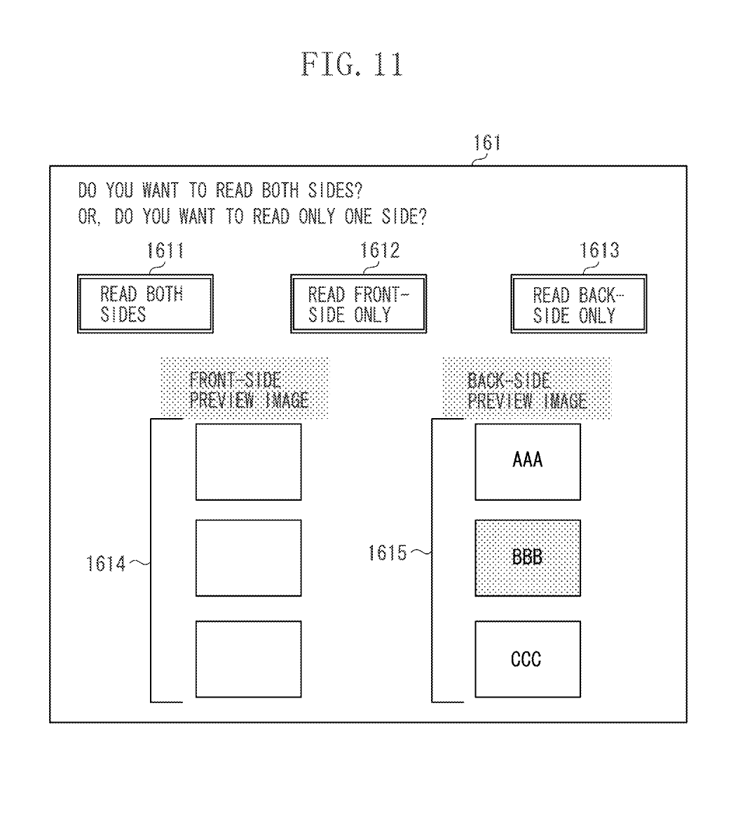

In step S404, the operation unit 160 displays the input image data on the liquid crystal panel 161 as preview images. A UI screen illustrated in FIG. 11 is an example of the preview images.

In step S405, the CPU 2100 determines whether the next page is present. If the CPU 2100 determines that the next page is present (YES in S405), the processing returns to step S401 to continue the image preview for the subsequent pages. If the CPU 2100 determines that the next page is not present (NO in S405), the processing ends.

<Preview Image>

FIG. 11 illustrates an example of a UI screen which is displayed on the operation unit 160 illustrated in FIG. 1. In this example, preview images are displayed on the UI screen by the image reading apparatus. More specifically, a preview of images on the first side of documents, which are read by the first reading unit, and a preview of images on the second side of the documents, which are read by the second reading unit, appear on the display while in a two-sided reading mode.

Referring to FIG. 11, a tab 1611 is used by a user to give an instruction to continue reading both sides of documents. A tab 1612 is used by a user to give an instruction to read only the front side of documents. A tab 1613 is used by a user to give an instruction to read only the back side of documents. When any one of the tabs 1611, 1612 and 1613 is pressed, the operation unit 160 notifies the CPU 2100 of the pressed tab. Front-side preview images 1614 are images on the front side of documents, which the operation unit 160 receives and displays on the liquid crystal panel 161 as preview images in step S404 illustrated in FIG. 10. Back-side preview images 1615 are images on the back side of documents, which the operation unit 160 receives and displays on the liquid crystal panel 161 as preview images in step S404 illustrated in FIG. 10. An instruction issued by the user pressing the tab 1611 is transmitted to the CPU 2100 as an instruction to continue supplying power to the first image processing unit including the first reading unit and to the second image processing unit including the second reading unit.

The number of the front-side preview images 1614 and the back-side preview images 1615 displayed increases every time step S404 is executed in the flow of image preview illustrated in FIG. 10.

<Flow of Power Control Based on Instruction Via Operation Unit>

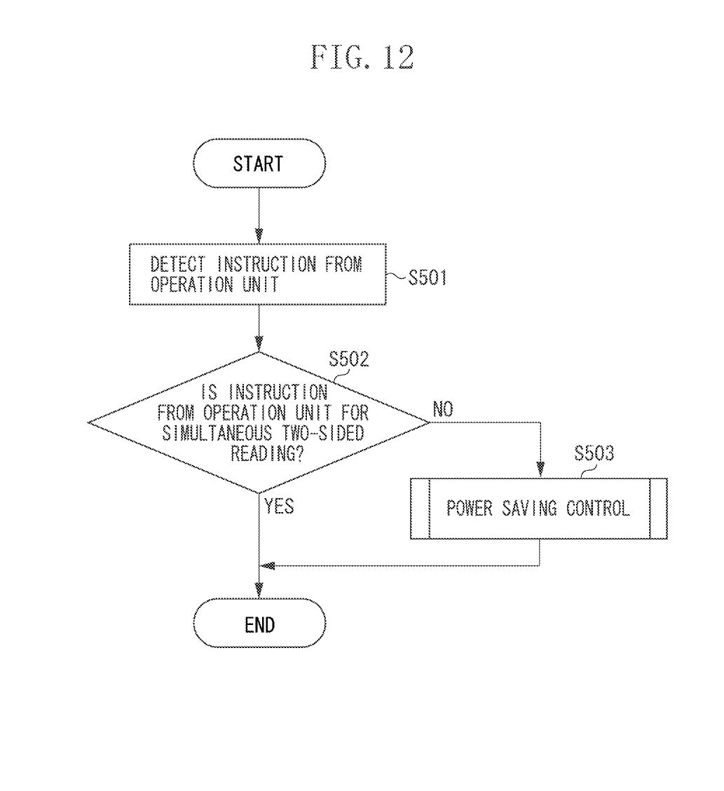

FIG. 12 is a flowchart illustrating a method for controlling the image reading apparatus according to the second exemplary embodiment. This is an example of power control performed by the image reading apparatus based on an instruction issued via the operation unit 160. The processing illustrated in the flowchart in FIG. 12 is realized by the CPU 2100 executing a program stored in the HDD 2130. A description will be given of an example in which the CPU 2100 determines whether, after previewing images, a user has issued an instruction to perform reading operation in a one-sided reading mode using either of the first reading unit and the second reading unit, or an instruction to perform reading operation in a two-sided reading mode using both the first reading unit and the second reading unit. Here, the first reading unit corresponds to the CCD sensor 1407, and the second reading unit corresponds to the CIS 1423.

In step S501, the CPU 2100 displays the UI screen illustrated in FIG. 11 on the liquid crystal panel 161. Here, the CPU 2100 detects that any one of the tabs 1611, 1612, and 1613 has been pressed based on user's selection operation.

In step S502, if the CPU 2100 detects that the tab 1611 has been pressed in order to issue an instruction to continue reading both sides of the documents (YES in step S502), the processing ends. If the CPU 2100 detects that the tab 1612 has been pressed in order to issue an instruction to read only the front side of the documents or that the tab 1613 has been pressed in order to issue an instruction to read only the back side of the documents (NO in step S502), the processing proceeds to step S503 to execute power saving control, and then the processing ends. The power saving control in step S503 is similar to the processing illustrated in the flowchart in FIG. 9.

The only difference between the first exemplary embodiment and the second exemplary embodiment is the judgment criterion in step S302 in the flowchart illustrated in FIG. 9, i.e., the judgment criterion on which the CPU 2100 determines which to shift to a power save mode, the front-side image processing control unit or the back-side image processing control unit. Thus, only the judgment criterion in step S302 will be described.

In step S302, the criterion for the CPU 2100 to proceed to step S303 is that the CPU 2100 detects in step S501 that the tab 1613 has been pressed in order to issue an instruction to read only the back side of the documents.

In step S302, the criterion for the CPU 2100 to proceed to step S304 is that the CPU 2100 detects in step S501 that the tab 1612 has been pressed in order to issue an instruction to read only the front side of the documents. Other processing executed in S301, S303, and S304 are similar to each other.

As described above, the CPU 2100 can determine to read both sides of documents, or only the front side or the back side of documents by displaying a preview of images read by the scanner 140 to allow a user to select the side of the documents to be read. Even when two-sided documents have many blank pages, this function prevents either of the front-side and back-side reading processing circuits from being automatically shifted to a power save mode, and thereby can avoid stopping reading either of the front-side and back-side of documents.

Also, even while a plurality of documents is being read, if a user selects reading only the front side or the back side of the documents, the reading processing circuit for the side not to be read can be shifted to a power save mode to reduce the power consumption.

According to a third exemplary embodiment, an example of printing a read image will be described. Particularly, in this example, it is assumed that the scanner 140 has the front-side illumination lamp 1402 and the back-side illumination lamp 1421 disposed in a position where the light sources thereof interfere with each other, and processing for preventing the printing operation from being affected by the interference is executed. In a standard apparatus which performs simultaneous two-sided reading, the front-side illumination lamp 1402 and the back-side illumination lamp 1421 are disposed in a position without interference with each other. However, there may be a case in which the front-side illumination lamp 1402 and the back-side illumination lamp 1421 are disposed close to each other due to a mechanical limitation or in order to synchronize the reading timing between the front side and the back side of documents.

Under such conditions, an image to be printed is processed according to the third exemplary embodiment, if either a light source of the front-side illumination lamp 1402 or a light source of the back-side illumination lamp 1421 is turned off by using the power saving control according to the first exemplary embodiment and the second exemplary embodiment.

<Printer IF Image Processing Unit>

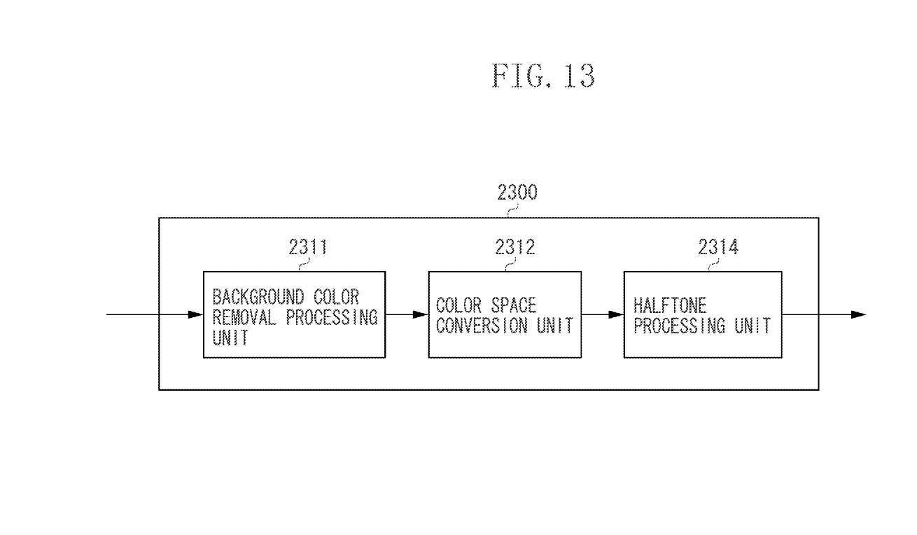

FIG. 13 is a block diagram illustrating an example of a configuration of the printer IF image processing unit 2300 illustrated in FIG. 3.

Referring to FIG. 13, a background color removal processing unit 2311 performs processing to remove a background color of an image to be printed. The operation of the background color removal processing unit 2311 is achieved using a simple arithmetic expression below.

For example, if an image with 10 bits each for R, G, and B is input, the operation is achieved by performing a simple calculation:

Output value R=input value R+(coefficient parameter*(input value R/2*input value G/2*input value B/2)/(cubic of 128)).

According to the input image, the CPU 2100 determines and sets a coefficient parameter for the background color removal processing unit 2311. A color space conversion unit 2312 performs luminance-density conversion. For example, an RGB input luminance image is converted into a cyan-magenta-yellow-black (CMYK) density image. A halftone processing unit 2313 performs halftone processing according to the output gray levels of the printer 120. For example, the halftone processing unit 2313 performs binary processing on a received high gray level image.

<Read Image Management Table>

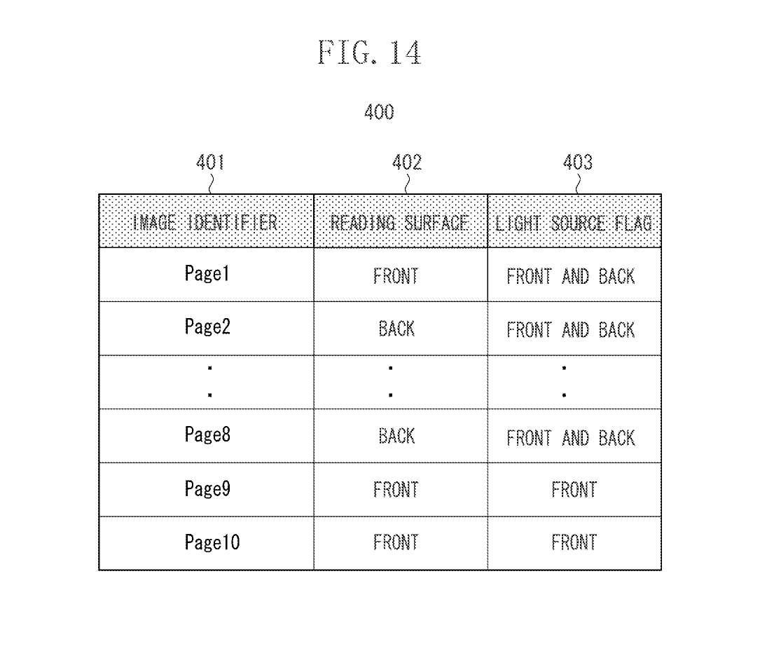

FIG. 14 illustrates a read image management table 400 which is managed on the HDD 2130 illustrated in FIG. 3. The read image management table 400 is necessary to realize the third exemplary embodiment, which is held by a memory like the HDD 2130 and is managed by the CPU 2100. The read image management table 400 is generated by the CPU 2100 to store in the HDD 2130 the image data read by executing the flow of image reading illustrated in FIG. 7.

Referring to FIG. 14, an image identifier 401 is an item for identifying read images. A reading surface 402 is an item indicating which sensor is used to read the image corresponding to the image identifier 401, the front side sensor or the back side sensor.

A light source flag 403 is a flag indicating the illumination lamp which is lit when the image corresponding to the image identifier 401 is read. “FRONT AND BACK” indicates that both the front-side illumination lamp 1402 and the back-side illumination lamp 1421 are lit when the image corresponding to the image identifier 401 is read. “FRONT” indicates that only the front-side illumination lamp 1402 is lit when the image corresponding to the image identifier 401 is read. “BACK” indicates that only the back-side illumination lamp 1421 is lit when the image corresponding to the image identifier 401 is read.

The coefficient parameter described referring to FIG. 14 includes at least four patterns. The first pattern is used when the reading surface 402 is front and the light source flag 403 is front and back. The second pattern is used when the reading surface 402 is back and the light source flag 403 is front and back. The third pattern is used when the reading surface 402 is front and the light source flag 403 is front. The fourth pattern is used when the reading surface 402 is back and the light source flag 403 is back.

By using the four patterns appropriately, an optimum background color removal is achieved according to the interference level between the front-side illumination lamp 1402 and the back-side illumination lamp 1421.

<Flow of Background Color Removal Parameter Change>

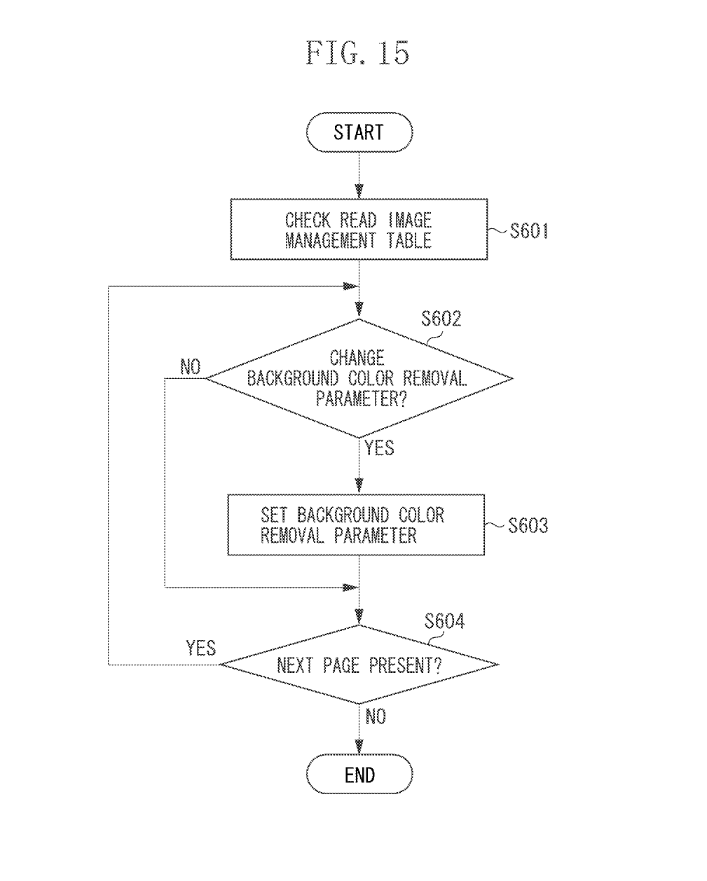

FIG. 15 is a flowchart illustrating a method for controlling the image reading apparatus according to the third exemplary embodiment. According to the third exemplary embodiment, when printing is executed, the coefficient parameter for the background color removal processing unit 2311 is determined. The processing illustrated in the flowchart in FIG. 15 is realized by the CPU 2100 executing a program stored in the HDD 2130. A description will be given of an example of second output image processing, in which an image processing parameter to be set for the second image data read by the second reading unit is adjusted according to the illumination state of a light source according to the first reading unit or a light source corresponding to the second reading unit when documents are read by illuminating each of the light sources.

In step S601, the CPU 2100 checks the read image management table 400 illustrated in FIG. 14. In step S602, the CPU 2100 checks whether to change the coefficient parameter for the background color removal processing unit 2311. Whether to change the parameter is determined based on whether there is a difference between the reading surface 402 and the light source flag 403 of the immediately preceding printed image and the reading surface 402 and the light source flag 403 of the image which is about to be subjected to printing processing. If the CPU 2100 determines that no difference exists (NO in step S602), the processing proceeds to step S604. If the CPU 2100 determines that a difference exists (YES in step S602), the processing proceeds to step S603.

In step S603, the CPU 2100 specifies a coefficient parameter for the background color removal processing unit 2311 according to the reading surface 402 and the light source flag 403. In step S604, the CPU 2100 checks whether an image to be printed exists. When the CPU 2100 determines that an image to be printed exists (YES in step S604), the processing proceed to step S601. If the CPU determines that no image to be printed exists (NO in step S604), the processing ends.

As described above, in a scanner capable of simultaneous two-sided reading, when a light source of the front-side illumination lamp 1402 and a light source of the back-side illumination lamp 1421 interfere with each other, an optimum background color removal can be achieved, even when power saving control is executed on the front-side image processing unit or on the back-side image processing unit according to the first exemplary embodiment and the second exemplary embodiment.

Additional embodiments can also be realized by a computer of a system or apparatus that reads out and executes computer executable instructions recorded on a storage medium (computer-readable storage medium) to perform the functions of one or more of the above-described embodiment(s), and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, these embodiments are not seen to be limiting. The scope of the following claims is to be accorded the broadest interpretation so as to encompass all such modifications and equivalent structures and functions.

This application claims the benefit of Japanese Patent Application No. 2012-266914 filed Dec. 6, 2012, which is hereby incorporated by reference herein in its entirety.

What is claimed is:

1. An image processing apparatus comprising:
a first image processing unit configured to process image data, read by a first reading unit, on a first side of at least one document;
a second image processing unit configured to process image data, read by a second reading unit, on a second side of the at least one document;
a determining unit configured to determine whether the first reading unit or the second reading unit has read a predetermined number of blank pages; and
a power control unit configured to, if the determining unit determines that the first reading unit or the second reading unit has read the predetermined number of blank pages, shut off power supply to the first image processing unit or the second image processing unit before reading of the at least one document is completed.

2. The image processing apparatus according to claim 1, wherein the determining unit determines, based on the image data of the first side or the image data of the second side, whether the first reading unit or the second reading unit has continuously read the predetermined number of blank pages.

3. The image processing apparatus according to claim 1, further comprising a specifying unit configured to specify the predetermined number of blank pages.

4. The image processing apparatus according to claim 1, further comprising an adjusting unit configured to adjust an image processing parameter to be set for the image data of the first side or an image processing parameter to be set for the image data of the second side read according to an illumination state of a light source corresponding to the first reading unit or a light source corresponding to the second reading unit when the at least one document is read by illuminating each of the light sources.

5. The image processing apparatus according to claim 4, wherein the image processing parameter is a background color removal parameter.

6. An image processing apparatus comprising:
a first image processing unit configured to process image data, read by a first reading unit, on a first side of at least one document;
a second image processing unit configured to process image data, read by a second reading unit, on a second side of the at least one document;
a display unit configured to display a preview of an image on the first side and a preview of an image on the second side;
a receiving unit configured to, after the displaying unit displays the images, receive a first reading instruction to read the images using either the first reading unit or the second reading unit, or a second reading instruction to read the images using both the first reading unit and the second reading unit; and
a power control unit configured to, if the receiving unit receives the first reading instruction, shut off power supply to either the first image processing unit or the second image processing unit, and if the receiving unit receives the second reading instruction, continue supplying power to the first image processing unit and the second image processing unit.

7. A method for controlling an image processing apparatus, the method comprising:
processing, by a first image processing unit, image data, read by a first reading unit, on a first side of at least one document;
processing, by a second image processing unit, image data, read by a second reading unit, on a second side of the at least one document;
determining whether the first reading unit or the second reading unit has read a predetermined number of blank pages; and
shutting off, if it is determined that the first reading unit or the second reading unit has read the predetermined number of blank pages, power supply to the first image processing unit or the second image processing unit before reading of the at least one document is completed.

8. A computer-readable storage medium storing computer executable instructions that control an image processing apparatus, the computer executable instructions comprising:
processing, by a first image processing unit, image data, read by a first reading unit, on a first side of at least one document;
processing, by a second image processing unit, image data, read by a second reading unit, on a second side of the at least one document;
determining whether the first reading unit or the second reading unit has read a predetermined number of blank pages; and
shutting off, if it is determined that the first reading unit or the second reading unit has read the predetermined number of blank pages, power supply to the first image processing unit or the second image processing unit before reading of the at least one document is completed.
